(19) United States
(12) Patent Application Publication
(10) Pub. No.: US 2007/0104323 A1
(43) Pub. Date: May 10, 2007

(54) Method and system for providing privacy to sender of a mail piece

(75) Inventors: Bradley R. Hammell, Fairfield, CT (US); Matthew J. Campagna, Ridgefield, CT (US); Robert A. Cordery, Danbury, CT (US); Leon A. Pintsov, West Hartford, CT (US); Frederick W. Ryan JR., Oxford, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/267,002

(22) Filed: Nov. 4, 2005

(51) Int. Cl. H04L 9/30

(52) U.S. Cl. 380/30

(57) ABSTRACT

Methods and systems for keeping information related to the sender of a mail piece private, while still allowing authorized parties to easily obtain the sender information if desired, is provided. Sender information for a mail piece is encrypted utilizing an identity-based encryption (IBE) scheme. The encryption key used to encrypt the sender information can be computed using recipient information. The corresponding decryption key can only be obtained from a trusted third party acting as a Private Key Generator (PKG). Only those parties authorized to have access to the sender information will be provided with the corresponding decryption key. The corresponding decryption key can then be used to decrypt the sender information into human readable form.

### FIELD OF THE INVENTION

The invention disclosed herein relates generally to processing of mail pieces, and more particularly to methods and systems for maintaining the sender's address, i.e., return address, of a mail piece private from unauthorized parties.

### BACKGROUND OF THE INVENTION

The United States accounts for the largest domestic letter traffic in the world, handling almost 200 billion pieces of mail each year. Many companies and private concerns use the mailing system to provide advertising information to customers or potential customers, and solicit information and responses from customers or potential customers. A few examples of the way the mail system is utilized includes, for example, advertising catalogues, sales brochures, and the like, subscription or potential business solicitations, information request responses, proxy statement responses, remittance documents (invoices for payment due) and the like.

Mail pieces are typically provided with the name and address of the sender, i.e., a return address or origination address, in clear text such that the return address is easily readable. Thus, any party that handles the mail piece can easily determine the sender of the mail piece. In many instances, knowing the sender of the mail piece provides enough information to determine the likely contents of a mail piece, such as, for example, bills, payments, credit card information, bank account information, personal items, etc. Thus, if the mail piece is inadvertently delivered to an incorrect recipient and the contents of the mail piece can be discerned based on the sender, there is the potential for a loss of privacy for the intended recipient. Additionally, the ability to discern the contents of a mail piece based on the sender can allow potential thieves to selectively remove mail pieces that may have valuable or important information from mail boxes easily and quickly, without the need to carefully examine each mail piece or take every mail piece from the mail box. Of course, these problems could be avoided by not providing any sender information on mail pieces. This results, however, in the inability of mail pieces that are undeliverable as addressed to be returned to the sender, as well as negating other benefits of having an identified sender, and therefore is not an acceptable solution.

Thus, there exists a need for methods and systems for keeping information related to the sender of a mail piece private, while still allowing authorized parties, e.g., the intended recipient, the postal authority, etc. to easily obtain the sender information if desired.

### SUMMARY OF THE INVENTION

The present invention alleviates the problems associated with the prior art and provides methods and systems for keeping information related to the sender of a mail piece private, while still allowing authorized parties to easily obtain the sender information if desired.

According to embodiments of the invention, the sender information for a mail piece is encrypted utilizing an identity-based encryption (IBE) scheme. The encryption key used to encrypt the sender information can be computed using recipient information, e.g., recipient address or some portion thereof, preferably combined with other information available to the recipient to contribute to uniqueness of each mail piece, e.g., date of mailing, etc. The resulting encrypted sender information is printed on the mail piece, preferably in a machine readable format. Thus, the sender information is kept private except for those parties capable of obtaining the corresponding decryption key required to decrypt the sender information. The corresponding decryption key can only be obtained from a trusted third party acting as a Private Key Generator (PKG). A party seeking to obtain a corresponding decryption key must first authenticate itself to the PKG, and upon proper authentication, the PKG will generate the corresponding decryption key based on the encryption key used to encrypt the sender information. If a party is unable to satisfactorily authenticate itself to the PKG, the PKG will not provide the corresponding decryption key. Thus, only those parties authorized to have access to the sender information will be provided with the corresponding decryption key. The corresponding decryption key can then be used to decrypt the sender information into human readable form.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates in block diagram form a system for processing a mail piece according to an embodiment of the present invention;

FIG. 2 illustrates in flow diagram form processing performed by a sender of a mail piece according to an embodiment of the invention; and

FIG. 3 illustrates in flow diagram form processing performed to determine the sender information of a mail piece according to an embodiment of the invention.

### DETAILED DESCRIPTION OF THE PREFERRED EMBODIMENTS

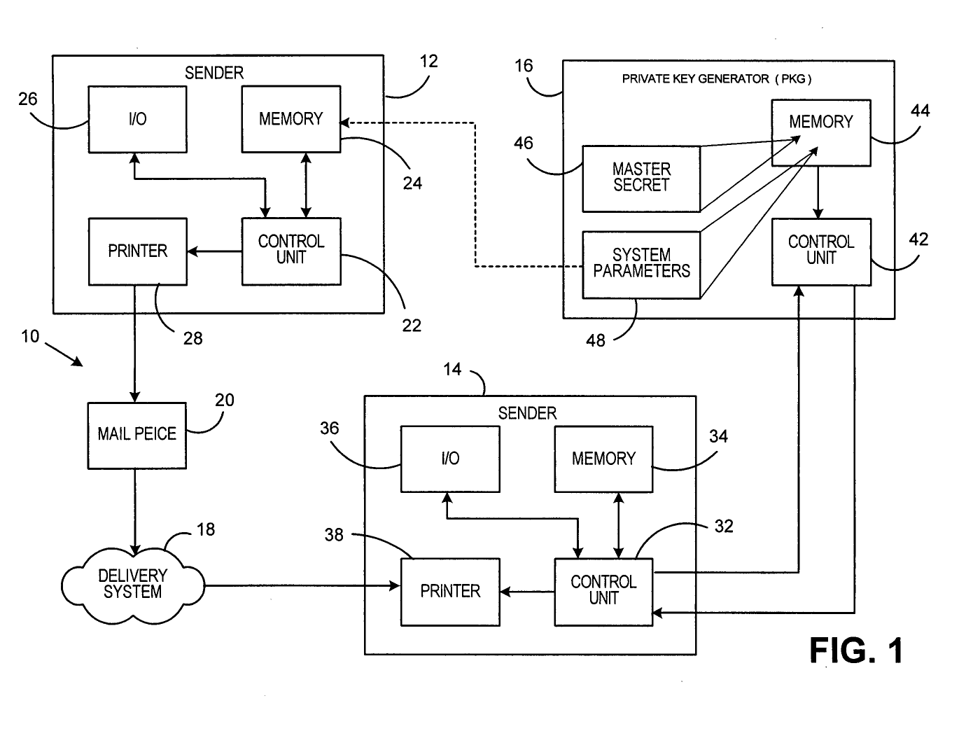

In describing the present invention, reference is made to the drawings, where there is seen in FIG. 1 in block diagram form a system 10 for processing a mail piece according to an embodiment of the present invention. The system 10 includes a sender utilizing a sender system 12, a recipient utilizing a recipient system 14 and a private key generator (PKG) 16. A sender that utilizes the sender system 12 can be any type of entity that sends mail to others, including, for example, a business such as a bank or credit card company, a corporation, a professional services organization, e.g., doctor, lawyer, laboratory, etc. A recipient that utilizes the recipient system 14 can be any party that receives a mail piece sent by the sender or obtains a mail piece (e.g., postal authority, law enforcement, etc.). It should be understood, of course, that while only a single sender system 12 and recipient system 14 are illustrated in FIG. 1, the present invention is not so limited and any number of senders and recipients can utilize the present invention.

The sender system 12 prepares a mail piece 20 for sending to a recipient system 14 utilizing a control unit 22, such as a computer processor or the like, that utilizes code stored in the memory 24 to control operation thereof. An input/output device (I/O) 26 can be used to provide additional inputs for generating the mail piece 20. The mail piece 20 includes at least the encrypted name and/or address of the sender 12 (e.g., return or origination address) generated according to the present invention as described below, which is preferably printed by the printer 28 on the mail piece 20 or a label for affixing to the mail piece 20. Optionally, the address of the recipient can also be printed by the printer 28. A delivery system 18, such as, for example a postal authority or private carrier, delivers the mail piece 20 to the recipient.

The recipient system 14 preferably includes a device that will allow the recipient to decrypt the encrypted return address on the mail piece 20 if so desired. The device could be, for example, a personal computer or the like that includes a control unit 32, such as a processor or the like, that utilizes code stored in the memory 34 to control operation thereof. An input/output device (I/O) 36 can be used to provide input/output signals from/to the recipient system 14. Optionally, a scanner 38 can be provided to scan the mail piece 20 if information on the mail piece 20 is provided in a machine readable format.

The PKG 16 provides a public-key cryptosystem utilized to encrypt/decrypt the return address of the mail piece 20. PKG 16 is preferably a trusted party, such as, for example, a reliable and reputable commercial entity or governmental entity. PKG 16 can be, for example, the postal authority or other service provider that typically provides secure services for the postal authority. Public-key cryptosystems allow two people to exchange private and authenticated messages without requiring that they first have a secure communication channel for sharing private keys. In a public-key cryptosystem, each person has a unique pair of keys: a private key that is a secret and a public key that is widely known. This pair of keys has two important properties: (1) the private key cannot be deduced from knowledge of the public key and the message, and (2) the two keys are complementary, i.e., a message encrypted with one key of the pair can be decrypted only with the complementary key of the pair. In one particular type of public-key cryptosystem, a person's public key can be computed from a public identifier associated with the person, such as, for example, the person's name, street address, e-mail address, telephone number, office address, or any combination thereof. Because the public key is a function of only the person's pre-existing public identifier rather than a key produced from a random seed, this kind of public-key cryptosystem is called an identity-based encryption (IBE) scheme. One implementation of an IBE scheme is described in detail in U.S. Published Patent Application No. 2003/0081785 A1, the disclosure of which is incorporated herein by reference.

The present invention utilizes an identity-based encryption scheme to provide privacy of a mail piece sender's name and/or address. The preferred IBE scheme utilized to implement the present invention is described in detail in the aforementioned U.S. Published Patent Application No. 2003/0081785 A1, although other similar IBE schemes may also be used. The preferred IBE scheme utilizes public keys that each consists of an arbitrary string derived from one or more identity related parameters for the intended recipient of a mail piece 20. PKG 16 has knowledge of a secret master key and utilizes a control unit 42, such as a processor or the like, to generate a corresponding private key for each given public key as described below. The PKG 16 performs a setup procedure to generate a master secret parameter 46 and system parameters 48 associated with the specific encryption/decryption algorithm utilized to encrypt/decrypt information. The master secret parameter includes, for example, some integer known only to the PKG 16. The system parameters include, for example, elliptic curve parameters with specific points on the curve used in the encryption algorithm, and are made publicly available for use as described below. The master secret parameter 46 and system parameters 48 can be stored in the memory 44. The master secret parameter 46 and system parameters 48 are used by the control unit 42 of PKG 16 to generate corresponding decryption keys as described below. The system parameters 48 are also used by the sender 12 in encrypting the return address for the mail piece 20 as described below.

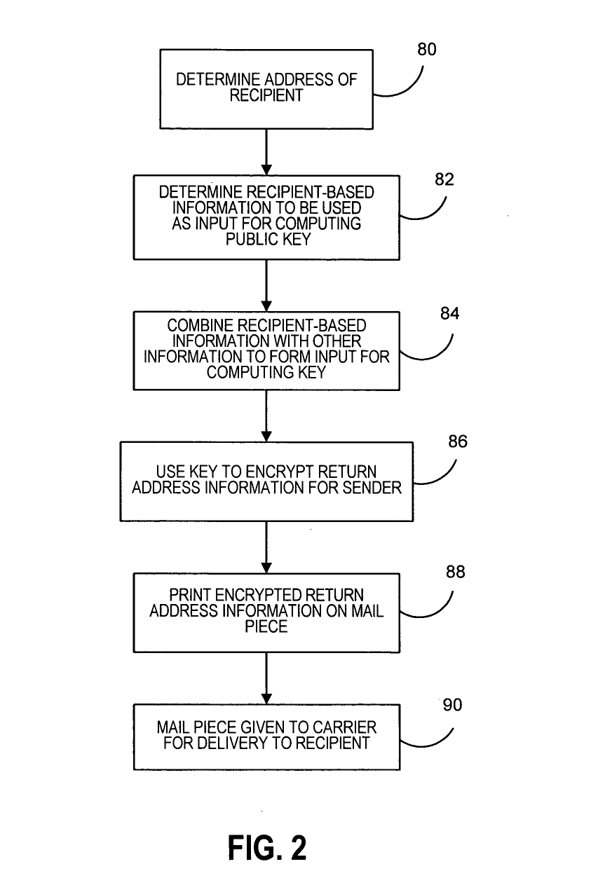

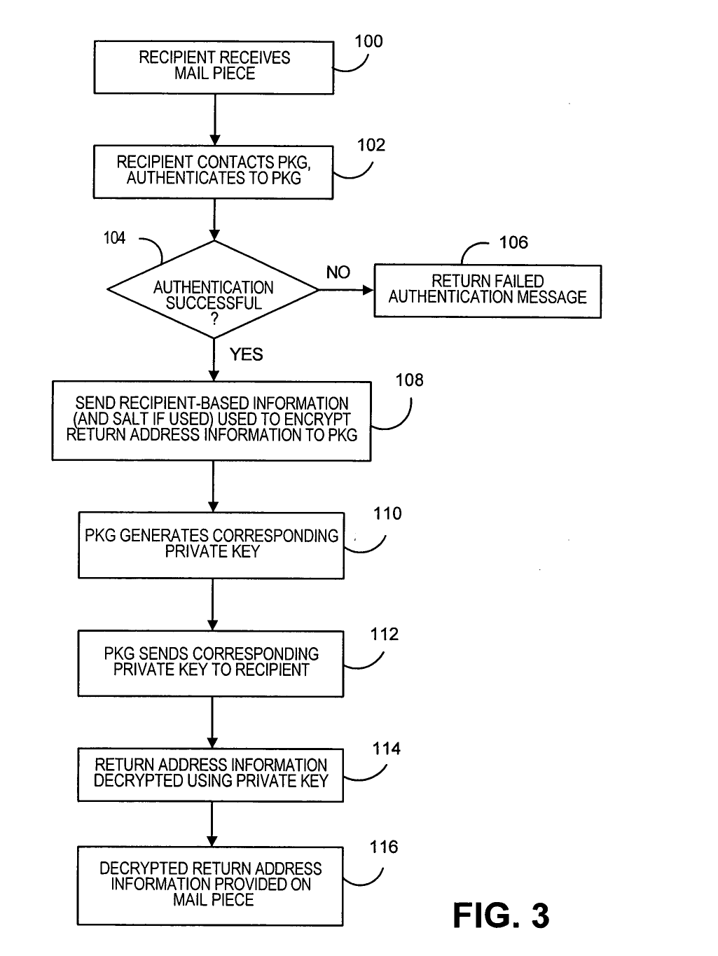

The operation of the system 10 will be described with respect to FIGS. 2 and 3. FIG. 2 illustrates in flow diagram form processing performed by the sender system 12 to prepare a mail piece 20 according to an embodiment of the invention for delivery to a recipient. The steps described in FIG. 2 would be performed, for example, by the control unit 22. In step 80; the address of the intended recipient of a mail piece 20 is determined. This can be performed in any manner, such as, for example, by utilizing an address list. Optionally, the sender system 12 can perform address cleansing, as is conventionally known, utilizing available address cleansing services offered by the postal service or other commercial entities to ensure that the address of the recipient is correct and complies with standard formats. The address of the recipient, or portions thereof, will be utilized as an input (optionally along with additional information as described below) for computing an encryption key, also referred to herein as the public key, used to encrypt the return address of the sender. Thus, the public key, and hence corresponding private key, will be different for each mail piece generated by the sender system 12. In step 82, recipient-based information that will be utilized as the input for computing the public key used to encrypt the return address of the mail piece 20 is determined. For example, the 11-digit zip code of the recipient, which uniquely identifies the address of the recipient, or some portion thereof, can be utilized as an input for computation of the public key. Optionally, in step 84, the recipient-based information is preferably combined with additional information, referred to as a salt, to form the input for computing a public key. The additional information is information that is readily available or obtainable by the recipient, such as, for example, the date of mailing. Thus, for example, mail pieces 20 that are mailed to the same recipient on different days will utilize different keys. If it is desired to send multiple mail pieces to the same recipient on the same day, either the same key can be used for all of the mail pieces or a different salt can be used for each mail piece. Preferably, a different key is utilized for each mail piece. Of course, if no salt is desired to be used, then the key computation will make use of only the recipient-based information and will be the same for every mail piece sent to the same recipient.

In step 86, the key formed in step 84 is used to encrypt the return address information of the mail piece 20, e.g., the name and/or address of the sender. The encryption is preferably performed using a known public encryption algorithm that can be part of an application being run by the control unit 22, such as, for example, a mail piece preparation application. The encryption algorithm utilizes the key formed in step 84 along with the system parameters 48 generated by the PKG 16 to encrypt the return address information. Preferably, the system parameters 48 of the encryption algorithm used by the control unit 22 are stored in the memory 24 of the sender system 12 (as illustrated by the dotted line in FIG. 1). The system parameters 48 can be provided to the sender system 12 on a recorded medium for downloading into the memory 24, or optionally can be obtained via a network communication between the sender system 12 and PKG 16. In step 88, the encrypted return address information is printed on the mail piece 20 by the printer 28, preferably in the location where the return address information is normally provided (upper left hand corner of the face of the mail piece). Alternatively, the encrypted return address information can be printed on a label by the printer 28 for affixing to the mail piece 20. Preferably, the encrypted information is printed in machine readable format, such as, for example, a bar code or the like. The printer 28 also prints the recipient-based information and salt (if used) used to encrypt the return address information on the mail piece 20 or label for affixing to the mail piece 20. This may also be printed in machine readable format and/or human readable format. Printer 28 can also optionally print the address information of the recipient 14 on the mail piece 20 if it is not already on the mail piece 20. If the control unit 22 and printer 28 are part of a postage meter, the control unit 22 can also generate an indicium (or Digital Postage Mark) evidencing payment of postage which can be printed on the mail piece 20 by the printer 28. In step 90, the mail piece 20 is given to delivery service, e.g., postal authority, for delivery to the recipient. While the return address information of the mail piece 20 is encrypted and provided on the mail piece 20 preferably in machine readable format, the address information of the recipient is provided on the mail piece 20 in conventional human-readable and/or machine readable format as desired. Thus, use of the present invention does not impact the delivery of the mail piece 20 to the intended recipient and the delivery of the mail piece 20 to the recipient can be accomplished in any conventional manner and need not be discussed any further.

Since the return address information for the sender of mail piece 20 is encrypted, the return address information for the sender remains private except for those parties that can decrypt the information. Decryption of the return address information requires the use of a corresponding decryption key, also referred to herein as the private key. FIG. 3 illustrates in flow diagram form the processing performed by, for example, the recipient system 14, to determine the return address information for the sender of a mail piece 20 according to an embodiment of the invention. In step 100, the mail piece 20 is received by the recipient. If it is not desired to decrypt the return (origination) address information on the mail piece 20, then no further action is necessary. If it is desired to decrypt the return address information, then in step 102 the recipient system 14 contacts the PKG 16, preferably utilizing a network or the like, and provides authentication information to the PKG 16. The PKG 16 will only provide private keys to authorized entities, and therefore must have some level of assurance as to the identity of the party requesting a private key. Such authentication can be based on a password or PIN previously established between the recipient and PKG 16. Alternatively, if there is no prior relationship established between the recipient and PKG 16, authentication can be accomplished by providing a credit card number or similar type of private and guarded information. Since credit card numbers are usually associated with a certain name and address, providing a credit card number associated with the recipient 14 can provide some level of assurance as to the identity of the recipient. Of course, the level of authentication required can be as high or low as desired.

In step 104, it is determined by the PKG 16 if authentication is successful. If not, then in step 106 a failed authentication message is returned to the recipient system 14, and no further action is taken by the PKG 16. If authentication is successful in step 104, then in step 108 the PKG 16 preferably provides an indication of successful authentication to the recipient system 14 and the recipient-based information, along with the salt (if used) that was used as the public key to encrypt the return address information is provided to the PKG 16 by the recipient system 14. This can be performed by scanning the mail piece 20, using the scanner 38, and reading the recipient-based information and salt (if used) used to encrypt the return address information. Alternatively, this information can be read from the mail piece 20 and manually input via the I/O device 36. The control unit 42 of the PKG 16, upon receiving the information in step 108, will then in step 110 generate the corresponding private key based on the recipient-based information and salt (if used) used to compute the public key used to encrypt the return address information utilizing the master secret parameter 46 and system parameters 48 stored in the memory 44. Since as noted above the public key used to encrypt the return address information is preferably different for every mail piece, the corresponding private keys that enable the return address information to be decrypted will also be different for every mail piece. Thus, the private key required for one mail piece will not be able to be used on any other mail pieces as long as the public keys are different.

Alternatively, if the information used as the encryption key is standardized and therefore can be predicted, e.g., the recipient's 11 digit zip code and date of mailing are always used as the encryption key, a user can obtain any number of decryption keys for future use, thereby removing the need to contact the PKG 16 each time it is desired to decrypt the return address information.

In step 112, the generated private key is sent to the control unit 32 of the recipient system 14. The generated private key can be sent using a secure channel, therefore protecting the confidentiality of the private key is desired. In step 114 the control unit 32 of the recipient system 14 uses the received private key to decrypt the return address information on the mail piece 20. The decrypted return address information, in human readable form, can then be output using the I/O device 36. Thus, although the return address information on the mail piece 20 is kept secret, a recipient using the recipient system 14 is able to determine the return address information if desired.

It should be noted that while FIG. 3 was described with respect to how a recipient of the mail piece 20 can decrypt the return address information on the mail piece 20, the same processing also applies to other parties that may wish to know the return address information, such as, for example, the postal authority, law enforcement agencies or other government agencies. As long as the party attempting to decrypt the return address information is authorized and able to authenticate itself to the PKG 16, the PKG 16 will generate and provide the corresponding private key for use in decrypting the return address information. Thus, certain entities such as the postal authority or law enforcement agencies can obtain the private key for any mail piece desired. The return address information will, however, remain private from any unauthorized parties that are unable to obtain the corresponding decryption key. Referring again to FIG. 3, if the party attempting to decrypt the return address information is a law enforcement agency or the postal authority (in the case of, for example, a mail piece 20 that is undeliverable as addressed and must be returned to the sender), then optionally in step 116 the decrypted return address information can be provided on the mail piece 20 to aid in easy identification of the sender such as, for example, to provide routing of the mail piece 20 back to the sender. This can be provided in human readable form and/or machine readable form as desired. Thus, although the return address information on the mail piece 20 is kept secret, if it is necessary for an authorized party to determine the return address information, it can be easily done. For example, if the postal authority has to return the mail piece 20 to the sender, the postal authority is able to determine the return address information if desired.

Thus, according to the present invention, a method and system for keeping information related to the sender of a mail piece private, while still allowing authorized parties to easily obtain the sender information if desired, is provided. While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for preparing a mail piece comprising:
obtaining information associated with a recipient of the mail piece;
selecting at least a portion of the information associated with the recipient of the mail piece to form an encryption key;
encrypting information associated with a sender of the mail piece using the encryption key to form an encrypted return address; and
providing the encrypted return address on the mail piece.

2. The method of claim 1, wherein the selected at least a portion of the information associated with a recipient of the mail piece includes an 11 digit zip code for the recipient.

3. The method of claim 1, wherein selecting at least a portion of the information associated with the recipient of the mail piece to form a key further comprises:
combining the selected at least a portion of the information associated with the recipient with additional information to form the encryption key.

4. The method of claim 3, wherein the additional information includes a date of mailing of the mail piece.

5. The method of claim 1, wherein providing the encrypted return address on the mail piece further comprises:
printing the encrypted return address on the mail piece.

6. The method of claim 1, wherein providing the encrypted return address on the mail piece further comprises: printing the encrypted return address on a label for affixing to the mail piece.

7. The method according to claim 1, wherein the information associated with a sender of the mail piece includes the sender's name.

8. The method according to claim 1, wherein the information associated with a sender of the mail piece includes the sender's address.

9. The method according to claim 1, wherein the information associated with a recipient of the mail piece includes an address of the recipient, and obtaining information associated with the recipient further comprises:
cleansing the address of the recipient.

10. A method for determining return address information for a mail piece having encrypted return address information provided thereon, the return address information being encrypted using an encryption key, the method comprising:
obtaining information used to form the encryption key utilized to encrypt the return address information from the mail piece, the information being associated with a recipient of the mail piece;
providing the obtained information to a private key generator;
receiving from the private key generator a corresponding decryption key for the encrypted return address; and
decrypting the encrypted return address using the corresponding decryption key.

11. The method according to claim 10, wherein providing the obtained information to a private key generator further comprises:
providing authentication information to the private key generator;
receiving an indication of successful authentication; and
providing the obtained information to the private key generator after receiving an indication of successful authentication.

12. The method according to claim 10, wherein obtaining information used to form the encryption key utilized to encrypt the return address information from the mail piece further comprises:
scanning the mail piece to read the information used to form the encryption key from the mail piece.

13. The method according to claim 10, further comprising:
providing the decrypted return address information on the mail piece.

14. A system for preparing a mail piece comprising:
means for selecting information associated with a recipient of the mail piece to form an encryption key;
means for encrypting information associated with a sender of the mail piece using the encryption key to form an encrypted return address; and
means for providing the encrypted return address on the mail piece.

15. The system of claim 14, wherein the selected information associated with a recipient of the mail piece includes an 11 digit zip code for the recipient.

16. The system of claim 14, wherein the information associated with the recipient of the mail piece is combined with additional information to form the encryption key.

17. The system of claim 16, wherein the additional information includes a date of mailing of the mail piece.

18. The system according to claim 14, wherein the information associated with a sender of the mail piece includes the sender's name and address.

19. The system according to claim 14, wherein the information associated with a sender of the mail piece includes the sender's address.
